(19) United States
(12) Patent Application Publication
(10) Pub. No.: US 2004/0258501 A1
(43) Pub. Date: Dec. 23, 2004

(54) Anti-vibration mechanism for lock nuts

(75) Inventor: Trevor William Bartlett Swan, Cambridge (GB)

Correspondence Address: MICHAEL BEST & FRIEDRICH, LLP, 100 E WISCONSIN AVENUE, MILWAUKEE, WI, 53202, US

(73) Assignee: Hypro Corporation, New Brighton, MN

(21) Appl. No.: 10/601,459

(22) Filed: Jun. 23, 2003

(51) Int. Cl. F16B 35/02

(52) U.S. Cl. 411/383

(57) ABSTRACT

An anti-vibration mechanism for lock nuts is disclosed. The invention is made up of a cylindrical tube having a hex nut midway along its length and external threads on each side of the hex. One of the threaded ends is adapted to have an internally threaded, knurled collar screwed onto it. To ensure this collar does not vibrate loose, a groove is machined into the threaded zone on which the knurled collar is to be screwed and an elastomeric O-ring is fitted into this groove. When the knurled sleeve is tightened, there is an increased frictional engagement between the O-ring and the threaded inner diameter of the knurled collar preventing loosening of the collar.

### BACKGROUND OF THE INVENTION

I. Field of the Invention This invention relates generally to lock nuts, and more particularly to lock nuts used with agricultural spraying equipment to attach nozzles to a spray boom. The present invention effectively prevents vibrations from loosening of the assembly as the boom is passed over the ground.

II. Discussion of the Prior Art

When operating equipment that often moves and traverses varied terrain, disengagement of components is a concern. Examples of this include agricultural applications like sprayers which utilize pumps, connectors, and nozzles that must be correctly aligned. These designs have significant difficulty preventing connective parts from loosening because of the non-stationary nature of the vehicles on which they are used. The vibrations generated by the vehicle movement jostle and loosen threaded bolt members, through which fluid flows, resulting in leaking or incorrect spray patterns from the nozzles.

It is well known that there are a substantial number of approaches for preventing a bolt from separating from a nut when subjected to vibration. To accomplish this task, prior inventions have included spring clips, T-nuts having a threaded bore, retaining wire and cotter pins, split locking ring washers, self tapping locking elements, aircraft nuts, and others. While all of these are valid approaches for securing a bolt to a nut, they each have limitations and disadvantages. For instance, many of these result in a permanently locked engagement which cannot be removed without destroying the device. Also, many of the devices are designed for specialized purposes and are not readily transferable between applications.

One relevant piece of prior art is U.S. Pat. No. 5,904,461. It discloses a T-nut having a threaded bore with a groove formed along the length of the bore for receiving a nylon walking ring. When a bolt is threaded into the T-nut, it engages the resilient locking ring and prevents vibration forces from loosening the bolt. This patent differs from the present invention because in the present invention it is the bolt that is provided with the groove and resilient locking O-ring. Aircraft nuts and corresponding bolts also have a rubber locking type insert, but locate this around the edge of the threaded nut.

Generally, the present invention is advantageous over the prior art due to new concepts included in locating an O-ring in a groove along the threaded length of the bolt or nozzle. Despite the broad range of prior art, there has yet to be an invention that modifies a bolt in the way described in this patent application.

### SUMMARY OF THE INVENTION

The present invention provides for an anti-vibration mechanism for lock nuts, adapted to be attached to a nozzle device, such as an agricultural sprayer. The invention includes a cylindrical tube adapted to be affixed to the sprayer having a hex nut formed midway along the length of the tube and external threads on each side of the hex. One side of the tube has a groove cut through the threads, into which an elastomeric ring fits. Last, an internally threaded nut or knurled collar is screwed onto the tube threads, over the elastomeric ring. This combination of assembly provides effective resistance against forces exerted in vertical and horizontal directions that would loosen the nut or collar from the nozzle member.

These and other objects, features, and advantages of the present invention will become readily apparent to those skilled in the art through a review of the following detailed description in conjunction with the claims and accompanying drawings in which like numerals in several views refer to the same corresponding parts.

### DESCRIPTION OF THE DRAWINGS

FIG. 1 is a side view of the standard anti-vibration mechanism for lock nuts of the present invention;

FIG. 2 is a side view of a disassembled anti-vibration mechanism with machined groove cuts in the threads of the present invention;

FIG. 3 is a side view of the assembled anti-vibration mechanism of the present invention;

### DESCRIPTION OF THE PREFERRED EMBODIMENT

The present invention represents broadly applicable improvements for lock nut design to eliminate loosening of the nut or knurled collar due to shock and vibration. The embodiments herein are intended to be taken as representative of those in which the invention may be incorporated and are not intended to be limiting.

Referring first to FIG. 1, there is shown a side view of the standard lock nut arrangement without the anti-vibration mechanism of the present invention. This figure discloses a cylindrical metal tube 1, hex bolt head 2, large external threads 3, small external threads 4, threads 5, and a knurled collar 6. This device uses a standard threaded bolt and nut arrangement that may be fitted to a wide variety of threaded nozzles, fittings and other applications.

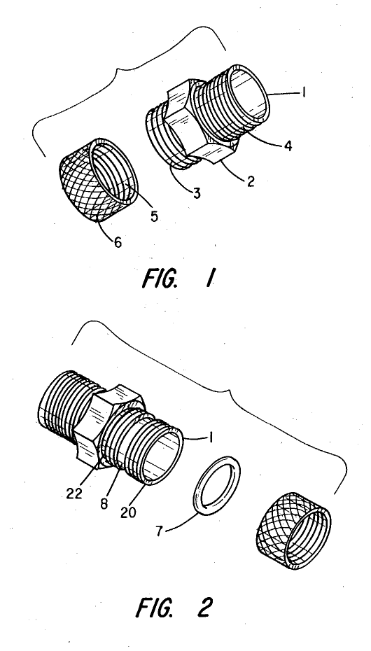

Referring next to FIG. 2, shown is a standard lock nut arrangement with the anti-vibration mechanism of the present invention. The anti-vibration mechanism includes elastomeric ring 7 with a groove 8. The elastomeric ring is somewhat small and has a diameter slightly smaller than the cylindrical metal tube 1. The groove 8 is machined out of the external threads 3 at a point midway between the ends 20 and 22 of the threads 3. It is possible to machine out some of these threads because the present invention is not placed in high pressure fluid locations. There is not much stress placed on this nut and thread connection and the integrity of the configuration remains in-tact despite its alteration.

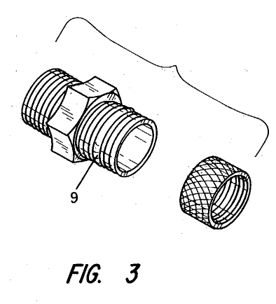

FIG. 3 shows the assembled anti-vibration device. Here, elastomeric ring 7 is fitted into groove 8. This assembled configuration 9 provides the anti-vibrational mechanism of the present invention. The elastomeric ring 7 stretches to tightly fit over the bottom of groove 8. The annular notch that is formed by groove 8 provides friction around the inner diameter of ring 7 as well as against the sides of the groove 8.

The present invention operates by first tightening threads 4 to a corresponding component. Next the knurled sleeve 6 is tightened onto the threaded portion of the tubular nozzle. This provides increased frictional engagement between the elastomeric O-ring 7 and the threaded inner diameter of the knurled collar, preventing vibration from loosening the knurled collar from the nozzle member. Fluid freely passes through the device and out the correctly aligned nozzles.

It can be seen, then, that the present invention provides an improved, apparatus for preventing loosening when a thread and nut configuration is subjected to repeated or extended vibration.

This invention has been defined herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself. For example, the threads 4 could be provided with a groove similar to the groove 8 and another elastomeric ring like ring 9 could be provided to create an anti-vibration mechanism on both sides of the fitting rather than just on one side.

What is claimed is:

1. An mechanism for inhibiting loosening of a nut due to vibration comprising:
(a) an externally threaded member;
(b) a channel located intermediate of opposite ends of the threading of said threaded member;
(c) a elastomeric ring retained by said channel; and
(e) an internally threaded nut screwed onto the externally threaded member and engaging said elastomeric ring.

2. The mechanism as set forth in claim 1, wherein said externally threaded member attaches to an agricultural nozzle.

3. A mechanism for inhibiting loosening of an internally threaded member from an externally threaded member due to vibration comprising:
(a) an externally threaded member having a channel located intermediate of opposite ends of the threading of said threaded member;
(b) an elastomeric ring retained by said channel; and
(c) an internally threaded member turned onto said externally threaded member and engaging said elastomeric ring.

4. The mechanism as set forth in claim 3, wherein said externally threaded member attaches to an agricultural nozzle.

5. An mechanism for inhibiting loosening of a nut due to vibration comprising:
(a) an externally threaded member;
(b) a channel located intermediate of opposite ends of the threading of said thread member;
(c) an internally threaded nut screwed onto the externally threaded member; and
(d) an elastomeric ring retained within said internally threaded nut and matched to said channel when screwed against it.

6. A method for attaching an anti-vibration mechanism to an agricultural nozzle comprising the steps of:
(a) machining a groove around one end of an externally threaded member forming a channel;
(b) inserting a elastomeric ring around said channel;
(c) threading a nut onto the machined side of the externally threaded member and over the elastomeric ring;
(d) whereby tightened rotation of the nut resists loosening caused by vibration of the mechanism.
